(19) United States
(12) Patent Application Publication
(10) Pub. No.: US 2026/0171585 A1
(43) Pub. Date: Jun. 18, 2026

(54) BATTERY MODULE

(71) Applicant: LG ENERGY SOLUTION, LTD., Seoul (KR)

(72) Inventors: Seongyeon WON, Daejeon (KR); Tae Geun KIM, Daejeon (KR); Yunhyeok KANG, Daejeon (KR); Young Bin LEE, Daejeon (KR)

(73) Assignee: LG ENERGY SOLUTION, LTD., Seoul (KR)

(21) Appl. No.: 18/713,516

(22) PCT Filed: Oct. 31, 2022
(86) PCT No.: PCT/KR2022/016837

§ 371 Date: May 24, 2024

(30) Foreign Application Priority Data
Nov. 26, 2021 (KR) 10-2021-0165065

(51) Int. Cl. H01M 50/289; H01M 50/211; H01M 50/271; H01M 50/296; H01M 50/503

(52) U.S. Cl. CPC H01M 50/289; H01M 50/211; H01M 50/271; H01M 50/296; H01M 50/503

(57) ABSTRACT

An aspect of the present disclosure includes a battery module, including a battery cell stack formed by stacking a plurality of battery cells, a plurality of electrode leads electrically connected to the plurality of battery cells, respectively, and disposed on one end of the battery cell stack, a bus bar plate having at least one terminal on one side thereof, and electrically connected to the plurality of electrode leads, and an insulation cover, having an inner side which is configured to face the one side of the bus bar plate, and having an opening that exposes the at least one terminal to an outside of the battery module at least partially, wherein the inner side of the insulation cover is spaced apart from the one side of the bus bar plate, and wherein the insulation cover comprises at least one blocking rib.

### TECHNICAL FIELD

This application claims priority to and the benefit of Korean Patent Application No. 10-2021-0165065, filed on Nov. 26, 2021, the disclosure of which is incorporated herein by reference in its entirety.

The present disclosure relates to a battery module, and in particular, a battery module in which a pair of blocking ribs protruding toward a bus bar plate is disposed at an insulation cover, to minimize the movement of high-temperature particles and gases toward a terminal of the bus bar plate, and an elastic gasket is disposed to fill a gap between an opening of the insulation cover and the terminal of the bus bar plate elastically, such that the discharge of the high-temperature particles and gases through the gap is minimized.

### BACKGROUND ART

At a time when more and more public attention is drawn to environmental issues, the global society has tried to reduce carbon emissions. As part of an effort to reduce carbon emissions, electric vehicles powered by electricity have been widely used rather than vehicles that are provided with a combustion engine and powered by fossil fuels.

Against this backdrop, there is a growing demand for a secondary battery that is mounted in an electric vehicle and used to store electricity. Additionally, coupled with increased importance of a personal mobile device such as a smart phone, a tablet PC and the like in our daily life, there is an increase in demand for a secondary battery for a mobile device to supply electricity to the mobile device.

Increasing demand for a secondary battery facilitates growing demand for research and development into a secondary battery.

In this context, demand for a multi module-structured battery pack increases, and in the multi module-structured battery pack, a battery module, where a plurality of secondary batteries connects in series/in parallel to enhance the capacity and efficiency of a secondary battery, is collected.

In the case where the plurality of battery cells connect in series/in parallel to constitute a battery pack, a battery module comprised of at least one of battery cells is constituted, and other components are ordinarily added to the battery pack with at least one of battery modules, to constitute a battery pack.

Further, heat is necessarily generated by a battery cell stack at a time of supply of power, and unless the heat generation is controlled effectively, the efficiency of the battery cell stack deteriorates rapidly, causing thermal runaway. In some cases, there can be a fire or an explosion.

In particular, the inner pressure of the battery module increases rapidly due to high-temperature particles and gases that are produced at a time of thermal runaway.

In the structure of a battery module of related arts, high-temperature particles and gases generated at a time of thermal runaway are released outward through a gap formed between a terminal provided at the upper end of a bus bar plate or a terminal provided at the bus bar plate, which is relatively vulnerable to the inner pressure, and an insulation cover, causing a fire.

In relation to this, a battery module is disclosed in CN Patent Publication No. 202110308925, and has a structure in which a plurality of heat insulation plates is disposed between a bus bar plate and a battery cell stack, to protect the bus bar plate from high-temperature particles and gases that are generated at a time of thermal runaway.

However, in the battery module according to the above-mentioned document, the plurality of heat insulation plates is segmentally disposed side by side, along the left-right direction, failing to prevent the leakage of the high-temperature gases effectively.

Furthermore, in the battery module according to the above-mentioned document, the high-temperature particles can move among the segmented heat insulation plates, failing to prevent the particles of the battery module from leaking outward effectively.

### DESCRIPTION OF INVENTION

### Technical Problems

The first objective of the present disclosure is to provide a battery module in which a pair of blocking ribs protruding toward a bus bar plate is disposed at an insulation cover, to minimize the movement of high-temperature particles and gases toward a terminal of the bus bar plate.

The second objective of the present disclosure is to provide a battery module in which an elastic gasket is disposed to fill a gap between an opening of the insulation cover and the terminal of the bus bar plate elastically, such that the discharge of the high-temperature particles and gases through the gap is minimized.

The third objective of the present disclosure is to provide a battery module in which a sheet member exhibiting thermal resistance is disposed between a battery cell stack and the bus bar plate, and entirely covers an upper surface and a front surface of the battery cell stack along the widthwise direction of the battery cell stack, to minimize damage to the bus bar plate, caused by high-temperature particles and gases, and to suppress the leakage of the particles and the gases.

Aspects according to the present disclosure are not limited to the above ones, and other aspects and advantages that are not mentioned above can be clearly understood from the following description and can be more clearly understood from the embodiments set forth herein. Additionally, the aspects and advantages in the present disclosure can be realized via means and combinations thereof that are described in the appended claims.

### Technical Solutions

An aspect of the current disclosure may include a battery cell stack being formed by stacking a plurality of battery cells, a plurality of electrode leads electrically connected to the plurality of battery cells, respectively, and disposed on one end of the battery cell stack, a bus bar plate having at least one terminal on one side thereof, and electrically connected to the plurality of electrode leads, and an insulation cover, having an inner side which is configured to face the one side of the bus bar plate, and having an opening that exposes the at least one terminal to an outside of the battery module at least partially, wherein the inner side of the insulation cover is spaced apart from the one side of the bus bar plate, and wherein the insulation cover comprises at least one of blocking ribs protruding from the inner side toward one surface of the bus bar plate and extending in a left-right direction to divide a space between the insulating cover and the bus bar plate into an upper space and a lower space.

At least one of the blocking ribs may be elongated from a left edge to a right edge of the insulation cover.

At least one of the blocking ribs may be disposed below the opening.

The blocking ribs may include a first blocking rib disposed below the opening, and a second blocking rib disposed below the first blocking rib.

The first blocking rib and the second blocking rib may be parallel to each other.

The first blocking rib and the second blocking rib may each be integrated with the insulation cover.

A first end of each of the first blocking rib and the second blocking rib may be integrally connected to the insulation cover, and wherein a second end of each of the first blocking rib and the second blocking rib may be configured to contact the bus bar plate.

The battery module may further include an elastic gasket that elastically fills a gap formed between the opening and at least one of the terminals.

The elastic gasket may be made of rubber exhibiting electric insulation and thermal resistance.

The elastic gasket may be provided with an opening coupling part and an expansion interposition part, wherein the opening coupling part is configured to close a gap between the terminal of the bus bar plate, exposed through the opening of the insulation cover, and an inner circumferential surface of the opening, wherein the expansion interposition part has a step between itself and the opening coupling part, and has a greater surface area than the opening coupling part, wherein a surface of the expansion interposition part contacts the inner side of the insulation cover, and wherein the opening coupling part has a penetration hole having a shape corresponding to a shape of the terminal of the bus bar plate, which is exposed through the opening of the insulation cover.

The battery module may further include at least one of sheet member that is fixed to an other side of the bus bar plate, wherein the at least one sheet member is configured to face the battery cell stack, wherein the at least one sheet member is thermal resistant and electrically insulated.

The at least one sheet member may include a perpendicular part being attached to the other surface of the bus bar plate and being elongated in an up-down direction, and a horizontal part connected to an upper end portion of the perpendicular part integrally, and extending from the perpendicular part toward the battery cell stack, wherein the horizontal part may cover an upper surface of the battery cell stack at least partially, and the perpendicular part may cover a front surface of the battery cell stack at least partially.

A width of the perpendicular part in the left-right direction may be greater than or the same as a width of the front surface of the battery cell stack in the left-right direction.

A width of the horizontal part in the left-right direction may be greater than or the same as a width of the upper surface of the battery cell stack in the left-right direction.

The at least one blocking rib may extend continuously in the left-right direction.

A distal end of the at least one blocking rib may contact the one side of the bus bar plate.

### Advantageous Effects

In a battery module according to the present disclosure, a pair of blocking ribs protruding toward a bus bar plate is disposed at an insulation cover, to minimize the movement of high-temperature particles and gases toward a terminal of the bus bar plate.

In the battery module, an elastic gasket is disposed to fill a gap between an opening of the insulation cover and the terminal of the bus bar plate elastically, such that the discharge of the high-temperature particles and gases through the gap is minimized.

In the battery module, a sheet member exhibiting thermal resistance is disposed between a battery cell stack and the bus bar plate, and entirely covers an upper surface and a front surface of the battery cell stack with respect to the widthwise direction of the battery cell stack, to minimize damage to the bus bar plate, caused by high-temperature particles and gases, and to suppress the leakage of the particles and the gases.

Specific effects are described along with the above-described effects in the section of detailed description.

### BRIEF DESCRIPTION OF DRAWINGS

FIG. 1 is an exploded perspective view showing a battery module of one embodiment.

FIG. 2 is a perspective view showing a first insulation cover in FIG. 1.

FIG. 3 is a front perspective view showing the battery module in FIG. 1.

FIG. 4 is a cross-sectional view of FIG. 3.

FIG. 5 is a front perspective view showing a first gasket in FIG. 4.

FIG. 6 is a partial enlarged view and a perspective view for describing a seat member provided in one embodiment of FIG. 1.

Description of reference numerals
1: Battery module 100: Battery cell stack 100a: Upper surface 100b: Front surface 110: Battery cell 111: Electrode lead 200: Frame 210: Lower frame 211: Bottom frame 212: Side frame 220: Upper frame 300: Insulation cover 310: First insulation cover 320: Second insulation cover 400: Sheet member 410: First sheet member 420: Second sheet member 500: Bus bar plate 500a: Bus bar 510: First bus bar plate 20: Second bus bar plate

### DETAILED DESCRIPTION OF EXEMPLARY EMBODIMENTS

The above-described aspects, features and advantages are specifically described hereafter with reference to the accompanying drawings such that one having ordinary skill in the art to which the present disclosure pertains can embody the technical spirit of the disclosure easily. In the disclosure, detailed description of known technologies in relation to the subject matter of disclosure is omitted if it is deemed to make the gist of the disclosure unnecessarily vague. Hereafter, preferred embodiments according to the disclosure are specifically described with reference to the accompanying drawings. In the drawings, identical reference numerals can denote identical or similar components.

The terms “first”, “second” and the like are used herein only to distinguish one component from another component. Thus, the components should not be limited by the terms. Certainly, a first component can be a second component, unless stated to the contrary.

Throughout the disclosure, each component can be provided as a single one or a plurality of ones, unless explicitly stated to the contrary.

When any one component is described as being “in the upper portion (or lower potion)” or “on (or under)” another component, any one component can be directly on (or under) another component, but an additional component can be interposed between any one component and another component on (or under) any one component.

When any one component is described as being “connected”, “coupled”, or “connected” to another component, any one component can be directly connected or coupled to another component, but an additional component can be “interposed” between the two components or the two components can be “connected”, “coupled”, or “connected” by an additional component.

The singular forms “a”, “an” and “the” are intended to include the plural forms as well, unless explicitly indicated otherwise. It is to be understood that the terms “comprise” or “include” and the like, set forth herein, are not interpreted as necessarily including all the stated components or steps but can be interpreted as excluding some of the stated components or steps or can be interpreted as including additional components or steps.

Throughout the disclosure, the phrase “A and/or B” as used herein can denote A, B or A and B, and the phrase “C to D” can denote C or greater and D or less, unless stated to the contrary.

Hereafter, the subject matter of the present disclosure is described with reference to the drawings that show the configuration of a battery module 1 of one embodiment.

### Entire Structure of Battery Module

Hereafter, the entire structure of the battery module 1 of one embodiment is described with reference to the accompanying drawings.

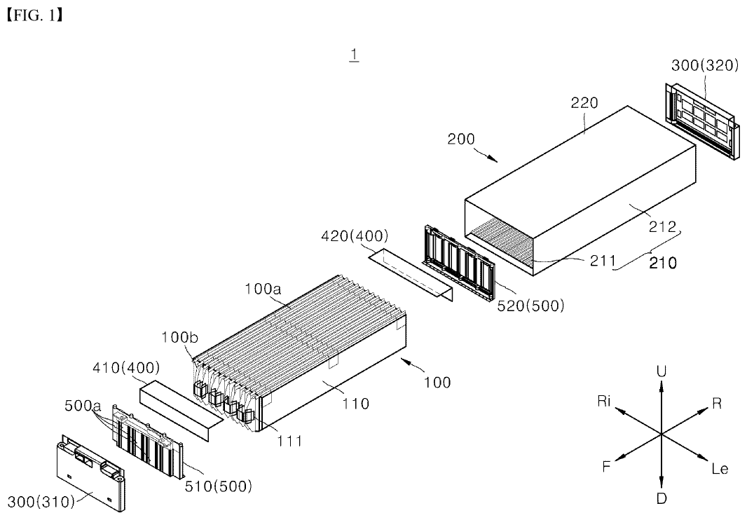

FIG. 1 is an exploded perspective view showing a battery module 1 of one embodiment.

Referring to FIG. 1, the battery module 1 of one embodiment may have a configuration in which a plurality of battery cells 110 is accommodated in a case or a housing that is comprised of a lower frame 210 and an upper frame 220.

The plurality of battery cells may constitute a battery cell stack 100 in which the plurality of battery cells are arranged in close contact with each other, in the state of being stacked.

The case or the housing of the battery module 1 may comprise a lower frame 210 surrounding the battery cell stack 100's lower surface and both lateral surfaces, an upper frame 220 being disposed at an upper surface side 100a of the battery cell stack 100, and a pair of insulation covers 300 being disposed to face an electrode lead 111 of the battery cell stack 100.

As illustrated, the lower frame 210 may comprise a bottom frame 211 constituting the bottom surface of the housing or the case, and a pair of side frames 212 constituting two lateral walls of the housing or the case, for example. It is preferable to integrally form the bottom frame 211 and the pair of side frames 212, in a way that a metal plate having predetermined strength is pressed.

The upper frame 220 covers an upper surface 100a of the battery cell stack 100, and like the lower frame 210, may be made of a metal plate having predetermined strength.

The upper frame 220 may be assembled to the lower frame 210 in a way that the upper frame 220 is coupled to upper end portions 211 of the pair of side frames 212.

Bottom surfaces of the end portions at both sides of the upper frame 220, and the upper end portions of the side frames 212 may be coupled based on laser-welding.

A rectangular pouch-type battery cell may be used as the plurality of battery cells 110, and two-way battery cells where an anode lead and a cathode lead constituting the electrode lead 111 protrude in an opposite direction, may be used as the battery cells 110.

The electrode leads 111 may electrically connect with a bus bar plate 500, such that the plurality of battery cells 110 connects in series or in parallel, through a bus bar 500a, depending on a desired output and capacity of the battery module 1. At this time, the bus bar plate 500, as illustrated, may comprise a first bus bar plate 510 disposed at the front of the battery cell stack 100, and a second bus bar plate 520 disposed at the rear of the battery cell stack 100.

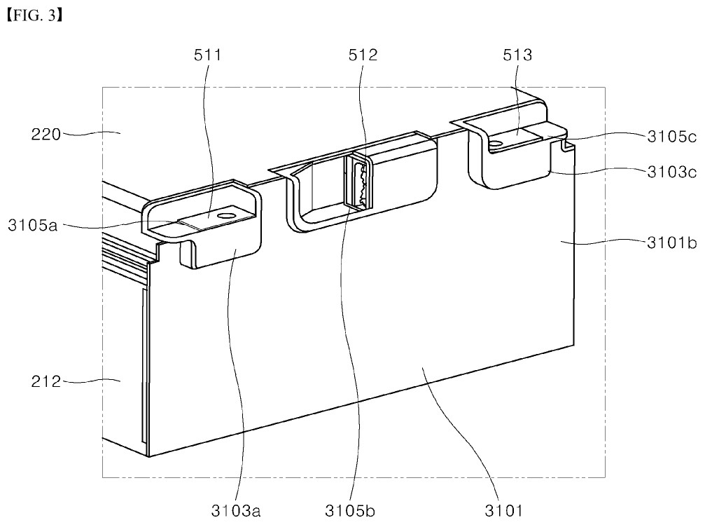

At least one of the first bus bar plate 510 or the second bus bar plate 520 may be provided with at least one of terminals 511, 512, 513 for supplying power to the outside. Following FIG. 3, the first bus bar plate 510 disposed at the front of the battery cell stack 100 is provided with a plurality of terminals 511, 512, 513, for example. At least one of the terminals 511, 512, 513 may comprise first, second and third terminals 511, 512, 513 that are exposed to the outside, through an opening 3103d of a first insulation cover 310, at least partially, and are spaced from one another, as described hereafter. Hereafter, the first, second and third terminals 511, 512, 513 are disposed at the first bus bar plate 510, for example, but not limited.

Depending on the specifications of a product to be applied, the battery cell stack 100 may further comprise a cartridge accommodating the battery cell 110, a buffer member, or a cooling member and the like.

A pair of sheet members 400 which is disposed to face the electrode lead 111, and a pair of insulation covers 300 may be disposed on an open front surface and an open rear surface of the frame 200.

The insulation cover 300 may be coupled to the frame in the state where the battery cell stack 100 is mounted in the frame 200, and the upper frame 220 is coupled to the lower frame 210.

It is preferable to couple the first insulation cover 310 to the open front surface of the frame 200 and to couple a second insulation cover 320 to the open rear surface of the frame 200.

The first insulation cover 310 and the second insulation cover 320 may be made of a material that has electric insulation and thermal resistance while having predetermined mechanical strength. A material for the insulation cover may be a thermoplastic synthetic resin exhibiting resistance against heat of 600° C. or greater. The insulation cover may be formed based on injection-molding to readily embody a specific shape. For example, it is preferable to manufacture the insulation cover with a wholly aromatic polyimide-based material, based on plastic injection molding.

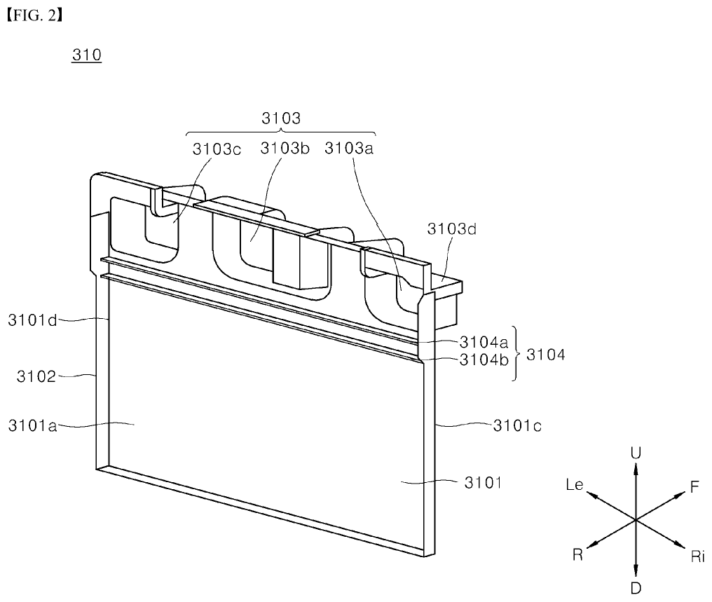

At this time, at least one of blocking ribs (3104 in FIG. 2) may be provided at the first insulation cover 310 of the battery module 1 of one embodiment, and minimizes the upward (U-direction) movement of high-temperature particles and gases that are generated at a time of thermal runaway of the battery cell stack 100, as described hereafter. A detailed configuration of the first insulation cover 310 provided with a blocking rib is described hereafter, with reference to the drawings following FIG. 2.

Additionally, the sheet member 400, as illustrated in FIG. 1, may be disposed between the upper end of the first insulation cover 310 and a front surface 100b of the battery cell stack 100, and prevent damage to the first insulation cover 310, which is caused by high-temperature particles and gases that are generated at a time of thermal runaway of the battery cell stack 100.

For the same reason, the sheet member 400 may be disposed between the upper end of the second insulation cover 320 and the rear surface of the battery cell stack 100, and prevent damage to the second insulation cover 320.

Hereafter, for convenience of description, the sheet member disposed at the first insulation cover 310 side is referred to as a first sheet member 410, and the sheet member disposed at the second insulation cover 320 side is referred to as a second sheet member 420, to distinguish the sheet members.

As described hereafter, the first sheet member 410 and the second sheet member 420 may be continuously formed to entirely cover the front edge and the rear edge of the upper surface 100a of the battery cell stack 100, along the left-right direction (Le-Ri direction), and as illustrated, may be respectively attached to the first insulation cover 310 and the second insulation cover 320, in a way that the first sheet member 410 and the second sheet member 420 bend in a “L” shape.

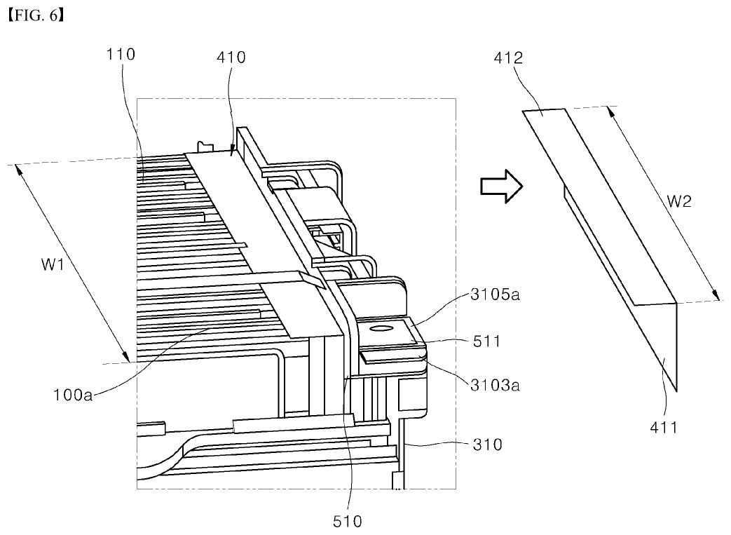

A detailed configuration of the sheet member 400 is described hereafter, with reference to FIG. 6.

Though not illustrated in FIG. 1, a first end plate and a second end plate, which are formed into a metal plate, may be respectively provided on an outer surface 3101b of the first insulation cover 310 and the outer surface of the second insulation cover 320, to protect the first insulation cover 310 and the second insulation cover 320 and improve the strength of the first insulation cover 310 and the second insulation cover 320.

### Detailed Structure of First Insulation Cover and Gasket in One Embodiment

FIGS. 2 and 3 are perspective views showing the first insulation cover 310 provided at the battery module 1 of one embodiment.

Referring to FIGS. 2 and 3, the first insulation cover 310 of the battery module 1 of one embodiment may comprise a cover main body 3101 having a flat plate shape.

The cover main body 3101, as described above, is coupled to the open front surface of the frame 200 and closes the front surface of the frame 200.

An edge rib 3102 may be continuously formed at a right edge 3101c, the lower edge and a left edge 3101d of the cover main body 3101, and protrude toward the frame 200 and enhance adhesion to the frame 200.

A terminal coupling part 3103, in which the above-described first, second and third terminals 511, 512, 513 are respectively accommodated, may be provided at the upper end of the outer surface 3101b of the cover main body 3101.

For example, the terminal coupling part 3103 may comprise first, second, third terminal coupling parts 3103a, 3103b, 3103c to accommodate the first, second and third terminals 511, 512, 513 respectively and separately, and the first, second, third terminal coupling parts 3103a, 3103b, 3103c may protrude forward from the cover main body 3101. As illustrated, the first, second, third terminal coupling parts 3103a, 3103b, 3103c may be spaced from one another as far as possible, to prevent interference among them.

An opening 3103d may be provided respectively at the first, second and third terminal coupling parts 3103a, 3103b, 3103c, to allow the first, second and third terminals 511, 512, 513 to be exposed outward at least partially.

A plurality of gaskets 3105a, 3105b, 3105c may be provided at the openings 3103d of the first, second and third terminal coupling parts 3103a, 3103b, 3103c at which the first, second and third terminals 511, 512, 513 are disposed respectively, to fill a gap formed between the opening 3103d and each of the terminals 511, 512, 513 elastically.

The gaskets 3105a, 3105b, 3105c may be made of rubber having predetermined elasticity and exhibiting electric insulation and thermal resistance. It is preferable to form the gaskets 3105a, 3105b, 3105c with a fluoropolymer-based synthetic rubber.

For convenience of description, a gasket provided at the first terminal coupling part 3103a is referred to as a first gasket 3105a, a gasket provided at the second terminal coupling part 3103b is referred to as a second gasket 3105b, and a gasket provided at the third terminal coupling part 3103c is referred to as a third gasket 3105c, among the plurality of gaskets 3105a, 3105b, 3105c.

The first, second and third gaskets 3105a, 3105b, 3105c may help to minimize high-temperature particles and gases, which are generated at a time of thermal runaway of the battery cell stack 100, from escaping outward through the gap between the opening 3103d and each of the terminals 511, 512, 513.

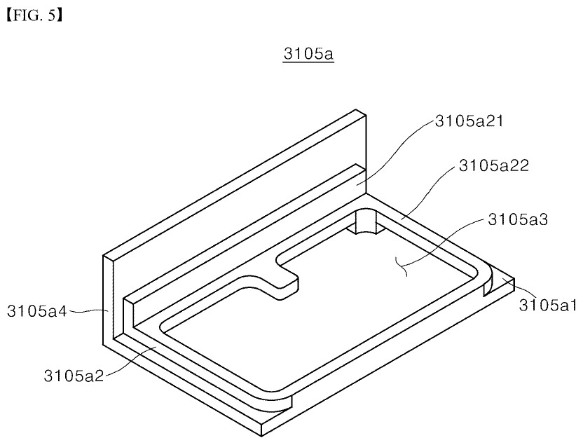

A detailed configuration of the first, second and third gaskets 3105a, 3105b, 3105c is described hereafter, with reference to FIG. 5.

As described above, at least one of blocking ribs 3104 may be provided on an inner surface 3101a of the cover main body 3101 as a means to minimize the upward (U-direction) movement of the high-temperature particles and gases that are generated at a time of thermal runaway of the battery cell stack 100.

Specifically, at least one of the blocking ribs 3104 serves as a barrier that blocks a space formed between a bus bar plate and an inner surface 3101a of the first insulation cover 310 and prevents high-temperature particles and gases from moving in the upward direction (U-direction) toward the opening 3103d of the first insulation cover 310.

To prevent the high-temperature particles and gases from moving in the upward direction (U-direction) toward the opening 3103d of the first insulation cover 310, the blocking rib 3104 may be disposed in a position lower than that of the opening 3103d with respect to the up-down direction (U-D direction).

In the illustrative embodiment of FIG. 2, the blocking rib 3104 comprises a first blocking rib 3104a and a second blocking rib 3104b that are spaced from each other in the up-down direction (U-D direction), and disposed side by side, but is not limited. Hereafter, the blocking rib 3104 comprising the first blocking rib 3104a and the second blocking rib 3104b is described with reference to the illustrative embodiment.

For convenience of description, with respect to the up-down direction (U-D direction), a blocking rib, which is provided in a position lower than that of the opening 3103d, at the lower side of the opening 3103d, is referred to as a first blocking rib 3104a, and a blocking rib, which is provided in a position lower than that of the first blocking rib 3104a, at the lower side of the first blocking rib 3104a, is referred to as a second blocking rib 3104b.

As described above, the first blocking rib 3104a and the second blocking rib 3104b serve as a barrier that blocks a propagation path P in which high-temperature particles and gases move in the upward direction (U-direction) toward the opening 3103d of the first insulation cover 310. To serve as a barrier described above, the first blocking rib 3104a and the second blocking rib 3104b protrude from the inner surface 3101a of the first insulation cover 310 toward the first bus bar plate 510.

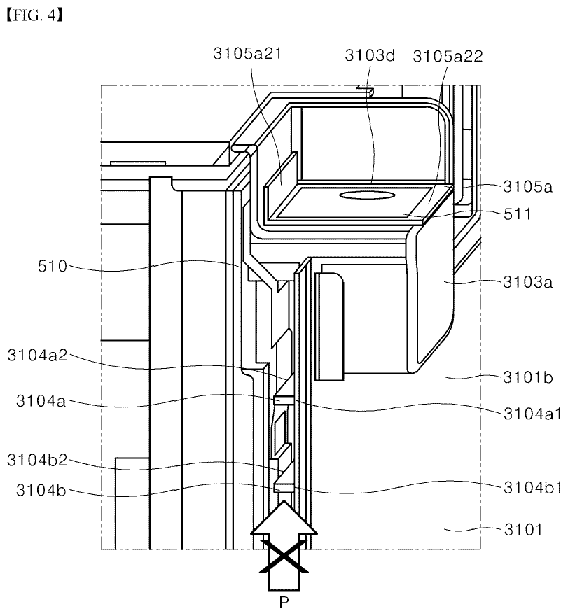

As illustrated in FIG. 4, a rear end portion 3104a2 of the first blocking rib 3104 a, and a rear end portion 3104b2 of the second blocking rib 3104b may preferably protrude in the front-rear direction (F-R direction) up to a position where the rear end portions contact the bus bar plate.

Additionally, the first blocking rib 3104a and the second blocking rib 3104b may be elongated across the cover main body 3101 along the left-right direction (Le-Ri direction), to entirely blocks a space formed between the first bus bar plate 510 and the inner surface 3101a of the first insulation cover 310. For example, the first blocking rib 3104a and the second blocking rib 3104b may be continuously elongated from the right edge 3101c of the cover main body 3101 of the first insulation cover 310 to the left edge 3101d thereof.

Further, the first blocking rib 3104a and the second blocking rib 3104b may be integrated to the first insulation cover 310. Accordingly, a front end portion 3104a1 of the first blocking rib 3104a and a front end portion 3104b1 of the second blocking rib 3104b may be integrated on the inner surface 3101a of the cover main body 3101, and the left end portions and the right end portions of the first blocking rib 3104a and the second blocking rib 3104b may be integrated with the edge rib 3102 of the first insulation cover 310.

Thus, the insulation cover may have a simpler structure than the structure in the case where the first blocking rib 3104a and the second blocking rib 3104b are provided separately, ensuring a reduction in manufacturing costs. Further, the insulation cover has resistance against heat of 600° C. or greater. Accordingly, in the embodiment, serving as a barrier to high-temperature particles and preventing the leakage of vent gases, the blocking rib may be designed to serve mainly as a barrier to high-temperature particles. Certainly, the blocking rib may also perform the function of preventing the leakage of vented gases.

The first blocking rib 3104a and the second blocking rib 3104b may minimize the upward (U-direction) movement of high-temperature particles and gases, but as described above, some of the particles and gases are likely to leak outward through the gap formed between the first insulation cover 310 and each of the terminals 511, 512, 513.

The first, second and third gaskets 3105a, 3105b, 3105c fill the gap formed between the first insulation cover 310 and each of the terminals 511, 512, 513 elastically, to suppress the leakage of high-temperature particles and gases having passed by the first blocking rib 3104a and the second blocking rib 3104b, as described above.

The positions or sizes of the first, second and third gaskets 3105a, 3105b, 3105c may differ, but in general, may be applied in almost the same way. Hereafter, the configuration of the first gasket 3105a illustrated in FIG. 5 is described. Unless described otherwise, the configuration of the first gasket 3105a may be applied to the configurations of the second gasket 3105b and the third gasket 3105c in the same way.

FIG. 5 shows a detailed configuration of the first gasket 3105a, for example. Referring to FIG. 5, the first gasket 3105a may comprise a base part 3105a1 that is formed into a rectangular frame the inside of which is open.

The base part 3105a1 is a portion that is held, coupled and fixed inside the opening 3103d of the first insulation cover 310, and as the pressure in the battery module 1 increases, supports the first gasket 3105a such that the first gasket 3105a does not escape outward.

Accordingly, the base part 3105a1 may have an outer shape that is greater than that of the opening 3103d.

Further, an opening coupling part 3105a2 may be provided on one surface of the base part 3105a1, and have a shape corresponding to the gap formed between the first insulation cover 310 and each of the terminals 511, 512, 513.

The opening coupling part 3105a2 substantially fills the gap formed between the first insulation cover 310 and each of the terminals 511, 512, 513. The outer circumferential surface of the opening coupling part 3105a2 may have a shape corresponding to the inner circumferential surface of the opening 3103d. The inner circumferential surface of the opening coupling part 3105a2 may have a shape corresponding to the shape of the outer circumferential surface of a portion of the terminal 511, which is exposed outward through the opening 3103d. At this time, the opening coupling part 3105a2 may have a width greater than that of the gap, such that the opening coupling part 3105a2 is elastically pressed and coupled in the state where the opening coupling part 3105a2 is placed in the gap.

As illustrated, the opening coupling part 3105a2 is formed into an “L” shape in which a perpendicular extension part 3105a21 and a horizontal extension part 3105a22 connect. Accordingly, the “L” shape of the opening coupling part 3105a2 corresponds to the “L” shape of the opening 3103d. A penetration hole 3105a3, which has a size corresponding to the size of the exterior of the first terminal 511, may be formed in the horizontal extension part of the opening coupling part 3105a2, to expose the first terminal 511 to the outside at least partially. The inner circumferential surface of the penetration hole 3105a3 may have a shape corresponding to the shape of the outer circumferential surface of a portion of the terminal 511 which is exposed outward through the opening 3103d.

Further, a fixation part 3105a4 may be provided in the end portion of one side of the base part 3105a1. The fixation part 3105a4 is a portion that is elongated in a direction different from the direction of the base part 3105a1, preferably, in a direction perpendicular to the direction of the base part 3105a1, and entirely fixes the first gasket 3105a to the first terminal coupling part 3103a. The fixation part 3105a4 connects to the perpendicular extension part 3105a21 of the opening coupling part 3105a2, and has a greater surface area than the perpendicular extension part 3105a21. The fixation part 3105a4 may be pressed and interposed between the first insulation cover 310 and the first bus bar plate 510 in the front-rear direction.

That is, a gap between the terminal of the bus bar plate, exposed through the opening of the insulation cover, and the inner circumferential surface of the opening of the insulation cover is closed by the opening coupling part of the gasket. The opening coupling part is not necessarily formed into a two-dimensional plane. If the opening of the insulation cover has a three-dimensional shape, the opening coupling part may have a three-dimensional shape having a perpendicular extension part 3105a21 and a horizontal extension part 3105a22, like the first gasket 3105a.

The gasket may be provided with an expansion interposition part that has a step between itself and the opening coupling part and has a greater surface area than the opening coupling part. In the case of a first gasket 3105a, the base part 3105a1 and the fixation part 3105a4 may correspond to the expansion interposition part. Accordingly, the expansion interposition part is not necessarily formed into a two-dimensional plane and may have a three-dimensional shape corresponding to the shape of the opening coupling part.

The outer circumferential surface of the opening coupling part may contact the inner circumferential surface defining the opening of the insulation cover, and the surface of the expansion interposition part may contact the inner surface of the insulation cover.

The gasket 3105a, 3105b, 3105c may be made of thermally resistant rubber, and serve as an encapsulant that prevents the leakage of vented gases. The gasket may exhibit resistance against heat of 200 to 300° C. In the embodiment, serving as a barrier to high-temperature particles and preventing the leakage of vented gases, the gasket may be designed mainly to prevent the leakage of vented gases. Certainly, the gasket may also serve as a barrier to high-temperature particles.

### Detailed Configuration of Sheet Member

Hereafter, a detailed configuration of the sheet member 400 provided in the battery module 1 of one embodiment is described with reference to FIG. 6.

As described above, the sheet member 400 may comprise a first sheet member 410 disposed between the upper end of the first bus bar plate 510 and the battery cell stack 100, and a second sheet member 420 disposed between the upper end of the second bus bar plate 520 and the battery cell stack 100.

The positions or sizes of the first sheet member 410 and the second sheet member 420 may differ, but in general, may be applied in almost the same way. Hereafter, the configuration of the first sheet member 410 illustrated in FIG. 6 is described. Unless described otherwise, the configuration of the first sheet member 410 may be applied to the configuration of the second sheet member 420 in the same way.

As illustrated in FIG. 6, the first sheet member 410 may comprise a perpendicular part 411 attached to the first bus bar plate 510 and elongated in the up-down direction (U-D direction), and a horizontal part 412 elongated in a direction where the horizontal part 412 becomes farther from the first bus bar plate 510.

The horizontal part 412 covers the upper surface 100a of the battery cell stack 100, and the perpendicular part 411 covers the front surface 100b of the battery cell stack 100.

For example, the perpendicular part 411 and the horizontal part 412 may be integrally formed, and formed in a way that a plate-shaped base material bends in a “L” shape.

As described above, the first sheet member 410 prevents damage to the first insulation cover 310, which is caused by high-temperature particles and gases generated from the battery cell stack 100.

To this end, the first sheet member 410 needs to entirely cover an edge that is formed as the front surface 100b and the upper surface 100b of the battery cell stack 100 meet, along the left-right direction (Le-Ri direction).

At this time, the widths W2 of the horizontal part 412 and the perpendicular part 411 of the first sheet member 410 in the left-right direction (Le-Ri direction) may be greater than or the same as the widths W1 of the battery cell stack 100 in the left-right direction (Le-Ri direction).

Additionally, at least, the horizontal part 412 of the first sheet member 410 needs to be formed continuously along the left-right direction (Le-Ri direction), to prevent high-temperature particles and gases from moving through the first sheet member 410. To this end, a space between the end portion of the left side and the end portion of the right side of the horizontal part 412 may be kept close entirely.

That is, a slit, or an open hole and the like may not be provided at all between the end portion of the left side and the end portion of the right side of the horizontal part 412.

The first sheet member 410 may be fixed to the inner surface of the first bus bar plate 510. Specifically, the perpendicular part 411 of the first sheet member 410 may be interposed between the front surface 100b of the battery cell stack 100 and the first bus bar plate 510, in the front-rear direction. It is preferable to firmly attach the perpendicular part 411 of the first sheet member 410 to the inner surface of the first bus bar plate 510, with a means of adhesion or a means of attachment. The horizontal part 412 of the first sheet member 410 may be interposed between the upper surface 100a of the battery cell stack 100 and the upper frame 220, in the up-down direction.

The embodiments are described above with reference to a number of illustrative embodiments thereof. However, embodiments are not limited to the embodiments and drawings set forth herein, and numerous other modifications and embodiments can be drawn by one skilled in the art within the technical scope of the disclosure. Further, the effects and predictable effects based on the configurations in the disclosure are to be included within the scope of the disclosure though not explicitly described in the description of the embodiments.

1. A battery module, comprising:
a battery cell stack formed by stacking a plurality of battery cells;
a plurality of electrode leads electrically connected to the plurality of battery cells, respectively, and disposed on one end of the battery cell stack;
a bus bar plate having at least one terminal on one side thereof, and electrically connected to the plurality of electrode leads; and
an insulation cover, having an inner side which is configured to face the one side of the bus bar plate, and having an opening that exposes the at least one terminal to an outside of the battery module at least partially,
wherein the inner side of the insulation cover is spaced apart from the one side of the bus bar plate, and
wherein the insulation cover comprises at least one blocking rib protruding from the inner side toward the one side of the bus bar plate and extending in a left-right direction to divide a space between the insulating cover and the bus bar plate into an upper space and a lower space.

2. The battery module of claim 1, wherein the at least one blocking rib extends from a left edge of the insulation cover to a right edge of the insulation cover.

3. The battery module of claim 2, wherein the at least one blocking rib is disposed below the opening.

4. The battery module of claim 3, wherein the at least one blocking rib comprises:
a first blocking rib disposed below the opening; and
a second blocking rib disposed below the first blocking rib.

5. The battery module of claim 4, wherein the first blocking rib and the second blocking rib are parallel to each other.

6. The battery module of claim 4, wherein the first blocking rib and the second blocking rib are each integrated with the insulation cover.

7. The battery module of claim 4, wherein a first end of each of the first blocking rib and the second blocking rib is integrally connected to the insulation cover, and
wherein a second end of each of the first blocking rib and the second blocking rib is configured to contact the bus bar plate.

8. The battery module of claim 1, wherein the battery module further comprises an elastic gasket that elastically fills a gap formed between the opening and the at least one terminal.

9. The battery module of claim 8, wherein the elastic gasket is made of rubber exhibiting electric insulation and thermal resistance.

10. The battery module of claim 8, wherein the elastic gasket is provided with an opening coupling part and an expansion interposition part,
wherein the opening coupling part is configured to close a gap between the terminal of the bus bar plate, exposed through the opening of the insulation cover, and an inner circumferential surface of the opening,
wherein the expansion interposition part has a step between itself and the opening coupling part, and has a greater surface area than the opening coupling part,
wherein a surface of the expansion interposition part contacts the inner side of the insulation cover, and
wherein the opening coupling part has a penetration hole having a shape corresponding to a shape of the terminal of the bus bar plate, which is exposed through the opening of the insulation cover.

11. The battery module of claim 1, wherein the battery module further comprises at least one sheet member that is fixed to an other side of the bus bar plate,
wherein the at least one sheet member is configured to face the battery cell stack, and
wherein the at least one sheet member is thermal resistant and electrically insulated.

12. The battery module of claim 11, wherein at least one sheet member comprises:
a perpendicular part attached to the other side of the bus bar plate, and extending in an up-down direction; and
a horizontal part connected to an upper end of the perpendicular part integrally, and extending from the perpendicular part toward the battery cell stack,
wherein the horizontal part covers an upper side of the battery cell stack at least partially, and the perpendicular part covers a front side of the battery cell stack at least partially.

13. The battery module of claim 12, wherein a width of the perpendicular part in the left-right direction is greater than or the same as a width of the front side of the battery cell stack in the left-right direction.

14. The battery module of claim 12, wherein a width of the horizontal part in the left-right direction is greater than or the same as a width of the upper side of the battery cell stack in the left-right direction.

15. The battery module of claim 1, wherein the at least one blocking rib extends continuously in the left-right direction.

16. The battery module of claim 1, wherein a distal end of the at least one blocking rib contacts the one side of the bus bar plate.
